(19) United States
(12) Patent Application Publication
(10) Pub. No.: US 2006/0150763 A1
(43) Pub. Date: Jul. 13, 2006

(54) Steering column of a motor vehicle

(75) Inventors: Hermann Raabe, Filderstadt (DE); Peter Steinkirchner, Schoenaich (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/518,748

(22) PCT Filed: Jun. 12, 2003
(86) PCT No.: PCT/EP03/06155

§ 371 Date: Jul. 26, 2005

(30) Foreign Application Priority Data
Jun. 24, 2002 (DE) 102 28 162.9

(51) Int. Cl. B62D 1/16

(52) U.S. Cl. 74/492

(57) ABSTRACT

The invention relates to a steering column train (1) for a motor vehicle, having a steering spindle (2) and a steering shaft (3) which are connected to each other via a torque-transmitting joint. For axial length compensation, an axially moveable link element (4) comprising at least one coupling member (12) with two parallel pivot axes (D_{BO}, D_{BU}) is provided. It is the object of the invention to develop a steering column train in which the decoupling vibrations from the steering gear is improved.

According to the invention, the like element (4) is coupled via a spigot cross element (17) to that end of the steering spindle (2) which lies opposite the steering wheel. In this case, the coupling member and the spigot cross element (17) are aligned with each other in such a manner that one axis of the spigot cross element (17) forms an axis of rotation (D_{BU}) of the coupling member (12).

### BACKGROUND AND SUMMARY OF THE INVENTION

The invention relates to a steering column train of a motor vehicle.

DE 37 23 034 A1 discloses a steering column train for a motor vehicle. Steering column trains for motor vehicles are distinguished by being of multi-part design in order, given predetermined construction-space proportions, to transmit the torque applied to the steering column train by the steering wheel to the steering gear. To this end, a steering spindle, which bears the steering wheel, is connected to a steering shaft, which leads to the steering gear, by means of a torque-transmitting joint. Torque-transmitting connections of this type are generally produced by universal joints, so that the steering column train runs as far as the steering gear in a manner corresponding to the construction-space proportions which are present. To adjust the steering wheel for comfort and to decouple vibrations from the steering gear, an axially moveable link element is inserted into the steering column train.

In DE 37 23 034 A1, the link element, which is inserted directly behind the steering gear, is designed as a simple link or parallelogram link, with a coupling member having two parallel axes of rotation which run approximately at right angles to the axial extent of the steering column train being provided in both variants.

The problem with link elements of this type is that the mass center of gravity of the steering column train is displaced as a function of the angle of rotation thereof and this may result in undesirable vibrations of the steering wheel or in feedback to the power steering, which have an adverse effect on the driving comfort.

It is therefore the object of the invention to develop a steering column train which avoids the disadvantages of the prior art.

The object is achieved according to the invention by a steering column train that includes a steering spindle, which bears the steering wheel, and a steering shaft, which is connected to the steering gear. The steering spindle and the steering shaft are connected to each other in a torque-transmitting manner. In contrast to the prior art, this torque-transmitting connection is not formed by a universal joint, but rather by a spigot cross element, which is coupled to that end of the steering spindle which lies opposite the steering wheel, and to a coupling member of a link element. The coupling member and the spigot cross element are aligned with each other in such a manner that one axis of the spigot cross element forms an axis of rotation of the coupling member.

By the direct connection of the coupling member to the spigot cross element and therefore to the end of the steering spindle, the longitudinal axis of the steering spindle and the central longitudinal axis of the coupling member always intersect at a common intersecting point. With a corresponding connection of the steering shaft to the coupling member, it is possible for there also to be a common intersecting point between the axis of rotation of the steering shaft and the longitudinal axis of the steering spindle. The distance between the two intersecting points is, if possible, kept as small as possible, so that the application of the forces of inertia of the steering shaft and of the link element can be defined unambiguously. The defined application of force makes it possible to avoid unbalanced masses in the steering column train, and therefore vibrations in the steering wheel are prevented. The length of the coupling member is determined as a function of the desired distance of displacement of the steering shaft, the capability of fitting the steering shaft onto the steering gear, the lower universal joint between the steering shaft and steering gear and the change in the geometry of the link element during steering movements. However, the smaller the size of the coupling member, the smaller the size of the unit, with the result that the crash behavior is improved.

In one preferred embodiment, the spigot cross element is mounted in a forked joint. The distance between the two intersecting points can therefore be further shortened, so that the wobbling movement of the steering shaft can be reduced.

Two transverse spigots of the spigot cross element can advantageously form a transverse bolt of the coupling member. The transverse bolt forms one of the axes of rotation of the coupling member. This enables a space-saving connection between the steering spindle and the steering shaft to be provided.

Two longitudinal spigots of the spigot cross element can form the pivot axis of the forked joint, thus making it possible for the steering shaft to be radially pivotable relative to the steering spindle.

The coupling member may comprise two side plates through which two transverse bolts pass. In this case, the transverse bolts are connected to the steering shaft and the steering spindle in such a manner that they form the axes of rotation of the coupling member.

At its end facing the steering spindle, the steering shaft may have a flange which ends at a distance from the longitudinal axis of the steering shaft. The greater this distance is kept, the larger can the length of the coupling member be configured.

Since the axis of rotation of the steering shaft and the longitudinal axis of the steering shaft are generally not identical, a lever arm is produced which is used to introduce torque into the steering spindle, i.e. into the steering wheel. The flange may be provided with an additional mass, so that a balancing of the steering column train in the “construction position” takes place in such a manner that torque is not introduced into the steering wheel. The construction position of a steering column train here is the position in which the vehicle is when driving straight ahead.

In order to absorb deformations, the steering shaft may have corrugated tube sections at least in some regions.

Irrespective of how the link element is configured, it is important, in order to reduce the feedback to the power steering, that the axis of the joint, the axis of rotation of the corrugated tube and the central axis of the coupling member intersect the longitudinal axis of the steering spindle.

### BRIEF DESCRIPTION OF THE DRAWINGS

A preferred refinement of the invention is explained with reference to the drawings.

FIG. 1 shows a steering column train in a perspective view from the side.

FIG. 2 shows a link element according to FIG. 1 in an extended position.

FIG. 3 shows a link element according to FIG. 1 in a compressed position.

### DETAILED DESCRIPTION OF THE DRAWINGS

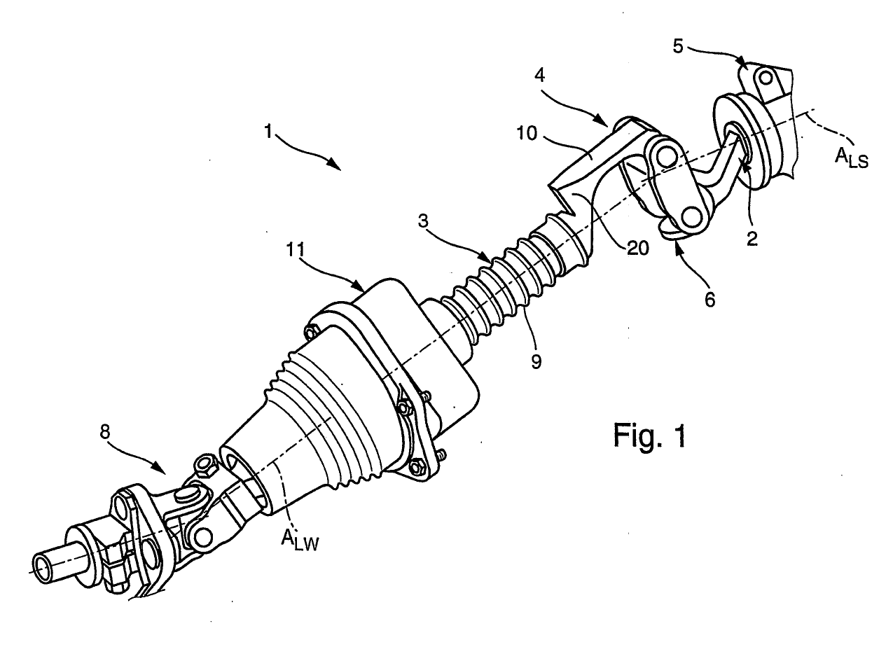

The illustration in FIG. 1 shows a steering column train 1 for a motor vehicle (not illustrated) in a perspective view obliquely from the side.

The steering column train 1 comprises a steering spindle 2 and a steering shaft 3 which are connected to each other via an axially moveable link element 4.

At its end (not illustrated further) facing the vehicle interior, the steering spindle 2 holds a steering wheel, the steering spindle 2 being mounted in a manner secured on the vehicle in a known manner via a casing tube 5 (illustrated in outline). That end of the steering spindle 2 which lies opposite the steering wheel merges in a hook-shaped manner into a forked joint 6 which ends at a distance from the longitudinal axis A_{LS} of the steering spindle 2.

At its lower end facing the engine compartment, the steering shaft 3 is connected via a universal joint 8 to the steering gear (not illustrated further). The upper region of the steering shaft 3 is formed by a corrugated tube section 9 to which a flange 10 is connected. The flange 10 extends from the corrugated tube section 9 in such a manner that it ends at a distance from the axis of the steering shaft A_{LW}. The lower end of the corrugated tube section 9 is adjoined by a sealing sleeve 11 which seals off the steering column train 1 when it is passed through an end wall (not illustrated).

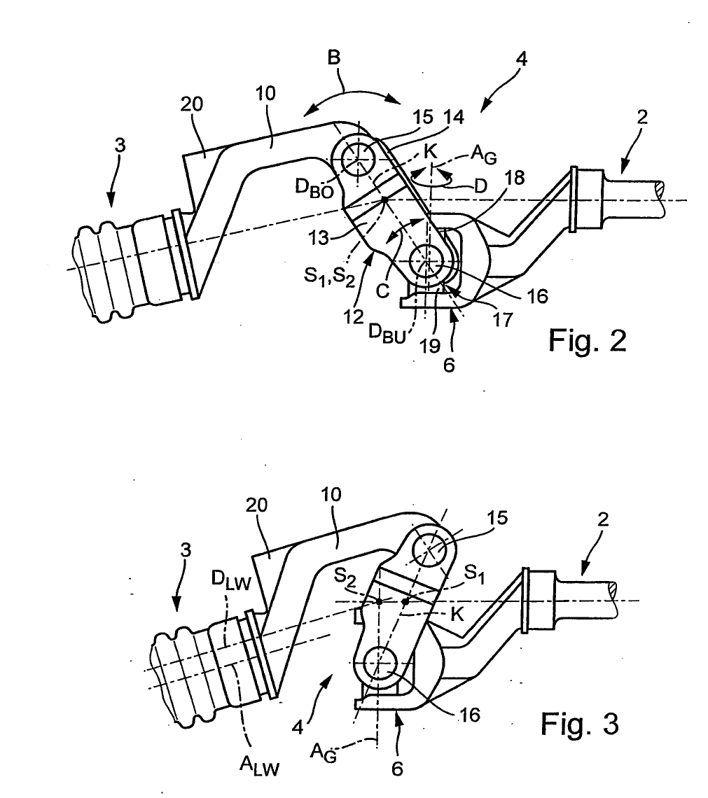

The link element 4 and its manner of operation are explained in greater detail below with reference to FIGS. 2 and 3.

The link element 4 comprises a coupling member 12 which is of approximately H-shaped configuration. Two transverse bolts 15 and 16 pass through the upper and lower ends of the two side plates 13 and 14, which run parallel to each other, of the coupling member 12.

The upper transverse bolt 15 is connected in an articulated manner to the flange 10 of the steering shaft 3, so that the flange 10 can execute a pivoting movement according to the arrow direction B about the axis of rotation D_{BO} formed by the transverse bolt 15.

The lower transverse bolt 16 forms two opposite transverse spigots of a spigot cross element 17 and is connected in an articulated manner to the coupling member 12, so that the coupling member 12 can execute a pivoting movement according to arrow direction C about the axis of rotation D_{BU} formed by the transverse bolt 16. The two longitudinal spigots 18 and 19 of the spigot cross element 17 form the axis A_{G} of the forked joint 6, so that the steering shaft 3 can be pivoted radially according to arrow direction D about the axis AG of the forked joint 6.

An additional mass 20 is provided for the flange 10, depending on the size of the steering column train 1, in order to balance the steering column train 1 for the rotational movement. The positioning and the size of the additional mass 20 are coordinated in such a manner with the vibrations produced in the steering wheel that a reduction thereof takes place. The additional mass 20 is to be arranged in such a manner that appropriate distribution of the mass enables the overall center of gravity of the steering shaft 3 and link element 4 to be situated on the axis of rotation D_{LW} of the steering shaft 3.

The coupling member 12 according to the invention and the connection thereof on the steering spindle 2 or steering shaft 3 enables the steering column train 1 to be pushed together in the axial direction. The steering shaft 3 can also be pivoted radially with respect to the steering spindle 2.

If an axial length compensation is required, for example during the adjustment of the steering wheel in the longitudinal direction or if vibrations are transmitted from the steering gear to the steering column train, this compensation is achieved by deflecting the coupling member 12 about its central line K according to arrow direction C. The pivot axis of the coupling member 12 is defined by the axis of rotation D_{BU} of the lower bolt 16.

The effect achieved by the refinement according to the invention of the torque-transmitting link element 4 is that the longitudinal axis A_{LS} of the steering spindle 2 intersects the coupling member 12 at an intersecting point S₁ approximately in the central line K thereof. In the construction position of the steering column train 1, the axis of rotation D_{LW} of the steering shaft 3, which does not have to be identical to the longitudinal axis A_{LW} of the steering shaft 3, is aligned in such a manner that a common intersecting point S₂ with the longitudinal axis A_{LS} of the steering spindle 2 arises. The two intersecting points lie optimally as close as possible to each other in order to shorten the lever arm of inertia forces. The torques introduced into the steering spindle 2 are therefore reduced, thus preventing the steering wheel from vibrating.

In the event of a crash, end-wall intrusions mean that the steering spindle 2 is subjected to high forces only at a very late point. First of all the link element 4 folds up. Only when the link element 4 has completely folded up, i.e. the formation of a block is achieved, does the lower corrugated tube section 9 become deformed. If construction space is appropriately available, the steering spindle 2 may also be provided with an additional corrugated tube section. As a result, it can then be ensured, inter alia, that an additional deformation path is made available in all crash situations. That is to say that irrespective of the direction from which the application of force arises, i.e. from the steering wheel or from the steering gear, the link element 4 has the possibility of folding up in each direction.

1. A steering column train for a motor vehicle, comprising a steering spindle which bears a steering wheel, a steering shaft connected to the steering spindle, a torque-transmitting joint forming the connection between the steering spindle and the steering shaft, and an axially moveable link element for axial length compensation, the link element comprising at least one coupling member with two parallel axes of rotation, and a spigot cross element being coupled to that end of the steering spindle which lies opposite the steering wheel, one axis of the spigot cross element forming an axis of rotation of the coupling member,
wherein the steering shaft has a flange which ends at a distance from the longitudinal axis of the steering shaft, the flange executing a pivoting movement about the upper axis of rotation of the coupling member.

2. The steering column train as claimed in claim 1,
wherein the spigot cross element is mounted in a forked joint which is arranged at that end of the steering spindle which lies opposite the steering wheel.

3. The steering column train as claimed in claim 2,
wherein two transverse spigots of the spigot cross element form a transverse bolt of the coupling member.

4. The steering column train as claimed in claim 3,
wherein two longitudinal spigots of the spigot cross element form a pivot axis of the forked joint.

5. The steering column train as claimed in claim 4,
wherein the coupling member comprises two side plates through which two transverse bolts pass, the transverse bolts forming the axes of rotation of the coupling member.

6. The steering column train as claimed in claim 5,
wherein the flange is provided with an additional mass.

7. The steering column train as claimed in claim 6,
wherein the steering shaft is formed with a corrugated tube section.

8. The steering column train as claimed in claim 4, wherein the flange is provided with an additional mass.

9. The steering column train as claimed in claim 8, wherein the steering shaft is formed with a corrugated tube section.

10. The steering column train as claimed in claim 3, wherein the flange is provided with an additional mass.

11. The steering column train as claimed in claim 10, wherein the steering shaft is formed with a corrugated tube section.

12. The steering column train as claimed in claim 2, wherein the flange is provided with an additional mass.

13. The steering column train as claimed in claim 12, wherein the steering shaft is formed with a corrugated tube section.

14. The steering column train as claimed in claim 1, wherein the flange is provided with an additional mass.

15. The steering column train as claimed in claim 14, wherein the steering shaft is formed with a corrugated tube section.
